(19) United States
(12) Patent Application Publication
(10) Pub. No.: US 2020/0019979 A1
(43) Pub. Date: Jan. 16, 2020

(54) SYSTEM AND METHOD TO MARKET INCENTIVE OFFERS VIA VOICE ASSISTANTS

(71) Applicant: SVM, LP, Arlington Heights, IL (US)

(72) Inventor: Tan Nhat Truong, Houston, TX (US)

(73) Assignee: SVM, LP, Arlington Heights, IL (US)

(21) Appl. No.: 16/106,517

(22) Filed: Aug. 21, 2018

Related U.S. Application Data
(63) Continuation-in-part of application No. 16/032,586, filed on Jul. 11, 2018.

(51) Int. Cl. G06Q 30/02; G10L 15/22; G06F 17/30

(52) U.S. Cl. CPC G06Q 30/0207; G10L 15/22; G10L 2015/221; G10L 2015/225; G06F 17/30592

(57) ABSTRACT

A system and methods for marketing incentive offers through voice assistants. The system may comprise: at least one voice assistant, voice assistant interface and marketing module. The voice assistant may be configured to receive and transmit voice commands and consumer data to a voice assistant interface. The voice assistant interface may be configured to tokenize voice commands. The marketing module may analyze tokens, voice commands, consumer data, consumer context, and/or retail offers to generate customized incentive offers. The system may comprise at least one data warehouse configured to store data and at least one fulfillment module to deliver incentive offers. The system may process data associated with a voice assistant user's preferences and/or profiles. Methods for systems of use are also described. Overall, the present invention utilizes data generated from a voice assistant to create at least one personalized incentive offer.

### CROSS-REFERENCE TO RELATED APPLICATIONS

This application is a continuation-in-part of U.S. patent application No. 16/032,586, filed Jul. 11, 2018, which is incorporated herein by reference in its entirety.

### BACKGROUND OF THE INVENTION

The last few years have seen the explosive growth and evolution of voice assistants such as Alexa® by Amazon®, Google Home® by Google®, Siri® by Apple®, Cortana® by Microsoft and Bixby® by Samsung®. These voice assistants have had a profoundly positive impact on the lives of consumers. For instance, consumers may now play their favorite radio stations by giving a voice command to Alexa® by Amazon® or they may ask Google Home® by Google® to make an appointment with their hairstylists. The myriad number of day-to-day voice interactions between a consumer and a voice assistant presents a marketing opportunity for businesses. Accordingly, there is a need for new types of systems and methods to market products through these voice assistants. These systems and methods, described herein, offer novel ways to enrich consumers' experiences by, marketing incentive offers that are personalized and tailored to these consumers.

### BRIEF DESCRIPTION OF THE INVENTION

The present invention relates generally to systems and methods for marketing products and services. Specifically, the invention relates to systems and methods for marketing incentive offers through voice assistants. The invention disclosed herein enriches consumer interaction with voice assistants by tailoring personalized marketing incentive offers to a particular consumer. These incentive offers may include promotional products including but not limited to gift cards, sales oilers and gift codes. In at least one embodiment, the system may include a specialized voice assistant interface (“VAI”) that receives voice commands and consumer data from at least one voice assistant and returns at least one personalized incentive offer which may be generated by a marketing module.

In a preferred embodiment, the marketing module may utilize voice commands and consumer data received from a voice assistant interface, as well as retail offers, to create offers tailored for a particular consumer. In addition, the marketing module may also utilize at least one consumer profile, as collected in a data warehouse, as well as data analytics and retail offers, to create offers tailored to a particular consumer.

The system of the present invention utilizes a voice assistant's capabilities to receive voice commands from a consumer and uses a voice assistant's ability to respond to a consumer's needs. The voice assistant may comprise any system capable of receiving verbal commands and acting thereon and may be any combination of software, hardware and/or firmware capable of carrying out the functions disclosed herein. The voice assistant may recognize and interpret natural language and perform tasks requested by the consumer. These tasks may comprise, for example, booking an appointment with hairstylist, generating information about current weather conditions, or setting up a reminder to call a consumer's contact. In one embodiment, a voice assistant may share these voice commands with the system. In addition to voice commands, voice assistants may be configured to share consumer data. Consumer data may include, for example, current geographical location, climate conditions in a consumer's location and many other parameters, which may assist the system in gaining insight into a consumer's preferences and activities. Additionally, voice commands and consumer data may not be shared at the time with the system by voice assistants. In one embodiment, voice assistants only share voice commands with the system and not consumer data.

The system harnesses the power of transmitting voice commands and consumer data in order to create a personalized incentive offer tailored to the consumer. One embodiment of the system uses an algorithm to analyze and learn from data points generated by voice commands and consumer data. The algorithm maps voice commands with consumer data to gain insights and create an incentive offer tailored for the consumer.

In one embodiment, after a voice assistant shares voice command and consumer data with the system, the system processes the data using a marketing module, effectively tokenizing, categorizing and enriching the data. The processed data is then utilized to create the incentive offer. For example, an incentive offer may be created by cross referencing the processed voice command and consumer data with data from retailers regarding sales and promotions. The system may take data from the voice assistant, integrate it with data from retailer offers about sales and promotions, and use the combined data to generate a real-time custom tailored incentive offer to a consumer. The incentive offer may be relayed back to the voice assistant and the voice assistant may present the incentive offer to the consumer for evaluation. For example, a consumer may ask a voice assistant to find nearby gas stations. This command may prompt the system to scan its database of retail offers for available offers pertaining to gasoline gift cards or gift codes. After finding an applicable retail offer, the system will process the offer and present it to the consumer, along with the locations of and directions to nearby gas stations. After the consumer accepts or rejects the offer, the system learns more about the consumer's preferences and may tailor a future incentive offer to better accommodate the consumer's preferences. Moreover, data collected throughout the process may be stored in the system's data warehouse so that it may be accessed by the system in the future.

Furthermore, in at least one embodiment, if a consumer verbally accepts an incentive offer via the voice assistant, the system may utilize a fulfillment module to ensure delivery of the offer—including but not limited to the gift code, coupon, or gift card—to the consumer. The fulfillment module may be configured to deliver the incentive offer via a consumer's preferred delivery method. Finally, the present disclosure includes at least one method utilizing the system described herein.

Additional objects, advantages and novel features of the examples will be set forth in the description which, upon examination of the following description and the accompanying drawings, will become apparent to those skilled in the art or the same may be learned by production or operation of the examples. The objects and advantages of the concepts may be realized and attained by means of the methodologies, instrumentalities and combinations particularly pointed out in the appended claims and known to those skilled in the art.

### BRIEF DESCRIPTION OF THE DRAWINGS

Additional objects and features of the invention will be more readily apparent from the following detailed description and appended claims when taken in conjunction with the Figures, in which:

FIG. 1 is a schematic diagram of an embodiment of the system, showing a transfer of data from a consumer to a voice assistant.

FIG. 2 is a schematic diagram of an embodiment of the system.

FIG. 3 is a schematic diagram of an embodiment of the system, showing the transfer of data from a voice assistant interface to the generation of incentive offers.

FIG. 4 is a schematic diagram of an embodiment of the system, showing the transfer of data to and from a marketing module.

### DETAILED DESCRIPTION OF THE INVENTION

Although the present disclosure is described with reference to specific exemplary embodiments, it will be evident that various modifications and alterations may be made to these embodiments without departing from the broader scope and essence of the disclosure, Accordingly, the specification and drawings are to be regarded in an illustrative rather than a restrictive manner.

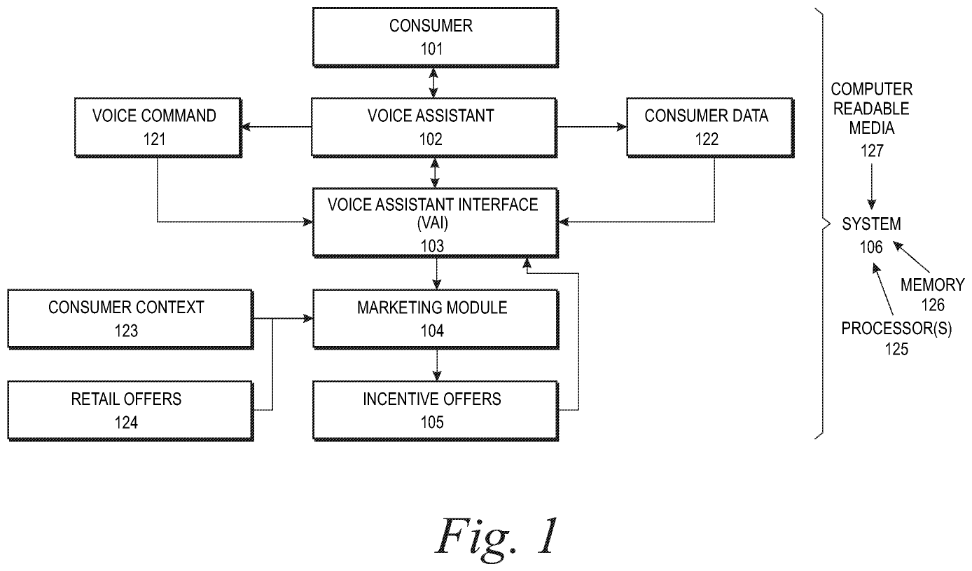

FIG. 1 illustrates an embodiment of a system 106 and shows how data may flow within the system 106. A consumer 101 interacting with a voice assistant 102 may transmit voice command(s) 121 along with consumer data 122 to a voice assistant interface 103. As used herein, a voice assistant 102 is any application program capable of understanding voice commands of a consumer 101 and completing delegated tasks. These delegated tasks may include, for example, playing the consumer's 101 favorite radio station, making an appointment with the consumer's 101 dentist, setting a consumer's 101 alarm, or finding gas stations near a consumer 101.

Data shared by voice assistant(s) 102 may include at least one voice command 121 received from the consumer 101. This data may include, but is not limited to, the current geographical location of consumer 101, current temperature in the consumer's 101 location, or traffic conditions in the consumer's 101 locality. The voice command 121 may also describe the consumer's 101 behavior and interests. These details help the system 106 gain further insit into the consumer's 101 preferences. Furthermore, the consumer's 101 commands may allow the system 106 to learn the habits of the consumer 101 by, for example, analyzing the activity of the consumer 101 at a specific time of day or describing the consumer's 101 dining preferences or preferred commute route. For instance, if a consumer 101 consistently listens to a particular radio station in the morning, the system 106 uses its learning capabilities to remember the station. If the station is a pop station, the system 106 may be configured to search for available retail offers 124 for pop concerts in the consumer's 101 location.

FIG. 1 illustrates how the system 106 returns incentive offers by using voice commands 121 and consumer data 122. The voice assistant 102 is a component which accepts consumers' voice commands 121. The voice assistant 102 may be configured to receive voice command(s) 121 from a consumer 101, and transmit the voice commands 121 to the VAI 103. The voice command 121 transmitted from the voice assistant 102 to the VAI 103 may be in its original or native format, as delivered by the consumer 101. The VAI 103 is any component that may be configured to receive the voice command 121 from the voice assistant 102 and direct it to a marketing module 104. Accordingly, in this embodiment, voice assistants 102 do not have to process the data before sharing it with the VAI 103. Like all other components discussed herein, the VAI 103 may be comprised of software, hardware, firmware, or any combination thereof.

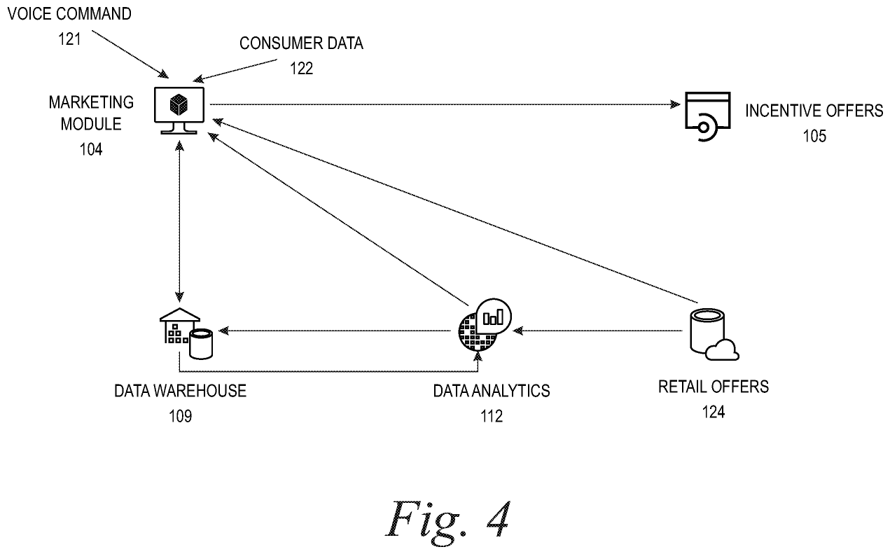

In one embodiment of the system 106, data from the VAI 103 may be combined with data about at least one retail offer 124 (“RO”). The system 106 may feed the combined data to the marketing module 104 where it is analyzed as shown in FIG. 1 and FIG. 4. In an embodiment, the marketing module 104 may be configured to utilize a set of self-learning algorithms to identify unique and distinguished keywords from a consumer's 101 voice command 121. The marketing module 104 may assign these keywords into categories obtained from consumer data 12.2 to create consumer context 123 described below. In essence, the consumer context 123 comprises a profile for a particular consumer. The consumer context 123 may categorize the current activity of consumer 101 in relation to the consumer's 101 current surroundings. In the preferred embodiment, the marketing module 104 utilizes a k-means clustering algorithm to find categories in the consumer data 122, with each category representing a unique trait of that consumer's 101 preferences and behavior. K-means clustering is an algorithmic function, often used in machine learning and data mining. K-means clustering may scan unlabeled data (for instance, data without a defined category) in order to find groups or keywords. This algorithm assigns each identified keyword from the voice command 121 to these categories. The assignment of keywords into categories is based on feature similarity. For example, if a consumer 101 asks about current weather conditions from the voice assistant 102, the algorithm will assign a “weather” keyword from voice command 121 to a “climate” category created from consirurer data 122. The algorithm is further capable of identifying additional categories within already identified categories. For example, when consumer data 122 is shared with the marketing module 104, the algorithm is capable of identifying upcoming festivals in consumer's locality based on consumer's location and the current date using publicly available information about applicable festivals for that location that is stored in data warehouse 109. The algorithm continues iterating over the keyword result set until each keyword is matched to a category. Keywords that could not be matched are grouped into an unmatched category. By matching keywords with categories, the marketing module 104 creates a well-defined set of categories comprising the consumer context 123 mentioned above. The system 106 and/or marketing module 104 may cross reference the consumer context 123 with at least one available RO 124 to yield at least one personalized incentive offer 105 for presentation to the consumer 101. The cross referencing may utilize a software algorithm that iterates over all the identified categories of consumer context 123 and determines if there is a match with any available RO 124. For instance, based on consumer data 122 and voice command 121 the system identifies that pop music is the music genre category for consumer context 123. Based on that music genre category information, if there is an available RO 124 for pop music the system will identify that as a match during the iteration process. Also, the above described algorithm may be designed to organize consumer context 123 into a data structure that enables continuous learning and may yield incentive offers 105. As discussed above, the consumer context 123 may include, but is not limited to, consumer 101 preferences, consumer 101's preferred music genre, a consumer's 101 current location, traffic conditions in the consumer's 101 locality, or a consumer's 101 schedule.

As discussed herein, consumer context 123 is utilized by the marketing module 104 to gain insights into the consumer's 101 activities, preferences and/or surroundings. These insights are then processed by the marketing module 104 to tailor a targeted incentive offer 105 to the consumer 101. For example, if a consumer 101 directs the voice assistant 102 to set an alarm in the morning, the voice assistant 102 may share this command with the system 106. Furthermore, in the morning consumer 101 may ask the voice assistant 102 to play loud music, and set a stop watch timer; these commands are also shared with the system 106. These details may be analyzed by the marketing module 104 to gain insight into the consumer's 101 morning activities and propensities. For instance, the nature of the commands to play loud music or set a stop watch may indicate that the consumer is involved in a morning workout. Consequently, the marketing module. 104 may generate an incentive offer 105 for workout related gift coupons or gift codes and transmit this offer via the voice assistant.

After receipt by the VAI 103, the system 106 may tokenize, categorize and enrich the unprocessed data. The VAI 103 may conduct a data tokenization step (“data tokenization”) 110. Data tokenization is a process by which the system 106 scans and identifies unique and distinguished terms or keywords within a voice command 121. Data tokenization 110 may refer to an algorithmic function that analyzes all words in a data set, for instance from the voice command 121, and counts each word's frequency of use. The more frequently used words may become keywords. This keyword identification may be used for generating personalized and targeted incentive offers 105 for the consumer 101 which are then transmitted to the consumer through the voice assistant.

After the input data is converted into tokens by the VAI 103, it may be forwarded to the marketing module 104. The marketing module 104 is any component that may be configured to perform at least two tasks: (1) a data categorization step (“data categorization”) 111; and (2) a data enrichment step (“data enrichment”) 112. Data categorization 111 is a process that organizes identified tokens from the data tokenization step 110 into available categories. These categories are formulated from consumer data 122. Although in a preferred embodiment, data categorization 111 occurs after the data has been tokenized 110, it may occur at a different time if necessary. In a preferred embodiment, the system 106 utilizes data categorization 111 to organize data into subgroups. For example, the system 106 may be configured to transfer all data relating to weather into a climate category. Other categories, including but not limited to, a location category, may also be used to categorize data. Because data categorization 111 provides the system 106 with an organized framework in which to analyze the data, it assists the system 106 in understanding the data transmitted to the marketing module 104 from the VAI 103.

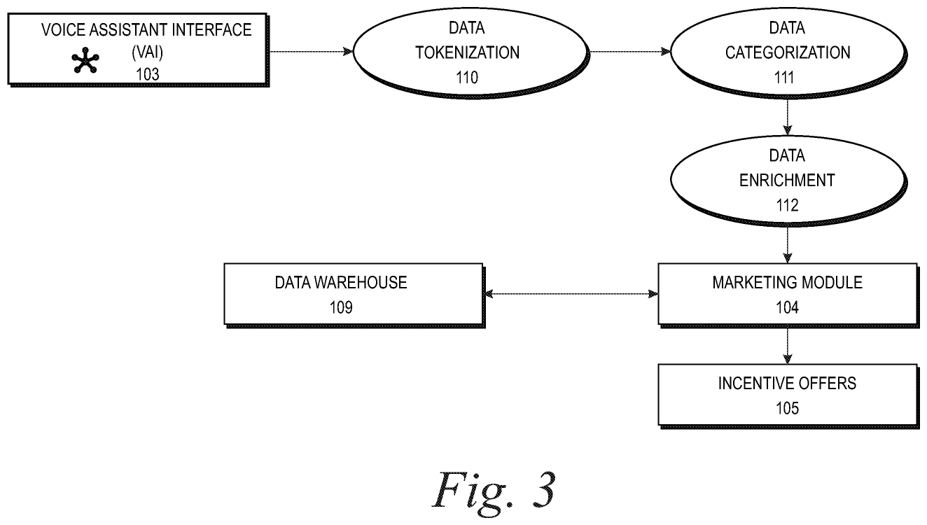

Another process that the marketing module 104 may perform is data enrichment 112. Data enrichment 112 is a step that adds additional keywords, or data attributes, to an already identified set of unique keywords. The data enrichment step 112 helps create an optimal incentive offer 105 for the consumer 101. These additional data attributes are stored in the system's 106 data warehouse 109. In an embodiment, the data warehouse 109 utilizes a database management system including but not limited to a Microsoft® SQL Server and is configured to store data. Moreover, the data warehouse 109 may be configured so that its data may be retrieved by the marketing module 104 or a data analyst in a data analytics step 112. During the process of data enrichment 112, each category of the consumer data 122 is populated with additional data attributes and then subsequently stored in the data warehouse 109. These additional data attributes are not part of voice command 121 or consumer data 122. For instance, an additional data attribute can be the current holiday season based on the location data that can be determined from consumer data 122. Data enrichment 112 may take place after the data is tokenized 110 and categorized 111. For example, if a consumer 101 uses a voice command to book a taxi for her work commute, data enrichment 112 may provide information about the last time the consumer took a taxi service and which route was taken by the consumer 101. Overall, data enrichment 112 may expand the system's 106 existing database and may integrate insights about a consumer's 101 preferences, activities and other proclivities into the existing knowledge it has from the voice assistant 102. The data tokenization 110, data categorization 111 and data enrichment 112 steps are further illustrated in FIG. 3.

Additionally, the system 106 may include one or more processors 125. The processor(s) 125 of the system 106 may execute one or more steps, causing the system 106 to execute a variety of functions as set forth herein. In various embodiments, the processor(s) 125 of the system 106 may comprise a central processing unit (“CPU”), a graphics processing unit (“GPU”), both a CPU and GPU, or other processing units or components known in the art. For instance, the processor(s) 125 may allow the system 106 to perform any action that allows the marketing module 104 to identify the consumer context 123 of the consumer 101. Furthermore, each component of the system 106 may possess its own local memory 126, which also may store program modules, data and/or one or more operating systems.

In an embodiment, the system 106 may include computer readable media 127. The computer readable media 127 of the system 106 may include any components that may be used to store data within the system 106, including but not limited to, voice command(s) 121 and consumer data 122. Depending on the system's 106 configuration and the type of voice assistant 102 implemented, the computer readable media 127 may include memory 126. Memory 126 may comprise many types of memory, including but not limited to volatile memory (for example, RAM), non-volatile memory (for example, ROM), flash memory, miniature hard drive, memory card, or any combination thereof.

As shown in FIG. 4, after the data is processed by the marketing module 104, the system 106 generates an incentive offer 105. The incentive offer 105 comprises at least one retail offer 124 that the system 106 tailors to the particular consumer 101. To generate the incentive offer 105, the marketing module 104 may cross reference consumer context 123 with at least one applicable retail offer 124. For example, the system 106 may match a gasoline gift card with a consumer 101 who requests information about nearby gas stations. The incentive offer 105 may then be presented to a voice assistant and, in turn, the voice assistant may present the incentive offer 105 to the consumer 101.

In an embodiment of the invention, the incentive offer 105 generated by the marketing module 104 is transmitted to the VAI 103. This incentive offer is then presented to the voice assistant 102 which includes a speaker to communicate the incentive offer 105 to the consumer 101. The voice assistant 102 includes a voice input device that allows the consumer 101 to communicate with the voice assistant 102. The consumer 101 utilizes the voice assistant's 102 voice input features to accept or reject incentive offers 105. The response of consumer 101 is then relayed back to the VAI 103.

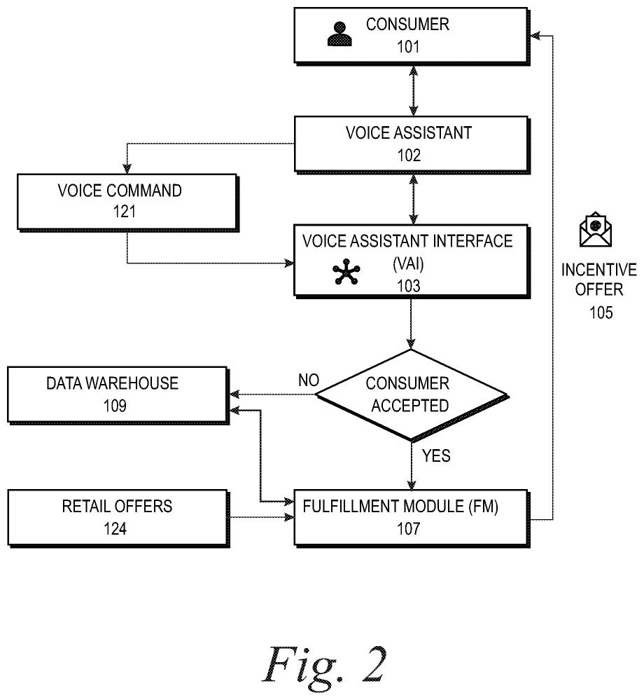

As illustrated in FIG. 2, in a preferred embodiment, the system 106 will present an incentive offer 105 to the consumer 101 via the consumer's voice assistant 102. After the consumer 101 communicates acceptance or rejection of the incentive offer 105, the voice assistant 102 is configured to receive the consumer's 101 response. After receiving the consumer's 101 response, the voice assistant 102 is configured to relay it to the VAI 103.

FIG. 2 also shows how the system 106 may be configured to forward the incentive offer 105 to a fulfillment module (“FM”) 107. If the presented incentive offer 105 is accepted by the consumer 101, the acceptance and details of incentive offer 105 may be transmitted to the FM 107 by the system 106. The FM 107 is a component which comprises software modules. The FM 107 is the component responsible for the delivery of the contents of incentive offers 105 to the consumer 101. For example, if the incentive offer 105 comprises a gift card, the FM 107 delivers the gift card to the consumer 101 via postal mail. If the incentive offer 105 comprises a digital gift code, the FM 107 delivers the digital gift code to the consumer 101 via electronic email or text message. The FM 107 may deliver incentive offer 105 contents using delivery methods including but not limited to post mail, electronic email or text message. The FM 107 component may record the details regarding the preferred delivery options of the consumer 101. These details include but are not limited to the postal address, the email address or the mobile number based on the previous delivery options selected by the consumer 101. In an embodiment, after the consumer 101 accepts an incentive offer 105 and selects a delivery option that was previously utilized, the FM 107 will deliver incentive offer 105 contents based on previously recorded delivery data in data warehouse 109 without asking for the same data again. Once processed by the FM 107, the system completes a cycle that begins with the consumer's 101 voice command 121 and ends with the consumer 101 receiving an incentive offer 105 via a preferred delivery method.

FIG. 3 illustrates the flow of data from the VAI 103 to a data warehouse 109. As discussed in connection with FIG. 1, the VAI 103 is a component that may be configured to receive, process and transmit data from voice assistants 102. The data received by the VAI 103 may comprise the consumer's 101 initial command and the consumer data 122 received from the voice assistant 102. This information is referred to herein as a voice command 121. The voice command 121 may then be tokenized into unique and distinguished keywords by the system 106 through a data tokenization 110 process. Specifically, during the data tokenization 110 process, the voice command 121 may be scanned to identify important keywords and the scanning process helps the system 106 provide relevant and personalized incentive offers 105 to the consumer 101. In an embodiment, a keyword may indicate a data string that may be defined based on the voice command 121. For example, if the consumer 101 has inquired about current weather from the voice assistant 102, the system 106 will identify weather as a keyword that is associated with consumer 101. The system may thereafter provide weather-related incentive offers 105 to the consumer 101.

After the voice command 121 and consumer data 122 is received by the VAI 103, it may be tokenized into unique keywords which are related to the consumer 101. The data tokenization 110 component may utilize a term frequency—inverse document frequency algorithm (“TF-IDF”) to identify and extract important keywords from the input voice command 121. A TF-IDF algorithm is an algorithm used in text mining by counting how many times a keyword is used in a text string. In this case, the text string is the voice command 121 from consumer 101 and each word in that text string is analyzed by TF-IDF algorithm to determine the keyword frequency, such as the number of times such keyword appears in the voice command 121. The keyword count value increases proportionally to the number of times a keyword appears in the voice command 121 and helps identify keywords that are frequently used by consumer 101. For example, if a consumer 101 directs the voice assistant 102 to set an alarm in the morning, the alarm and morning keywords will be identified as the consumer's 101 frequently used keywords.

The identification of these distinguished keywords will assist the marketing module 104 in gaining insights for creating personalized incentive offers 105 for the consumer 101 and transmitting these offers via the voice assistant 102. For instance, if a consumer 101 tries to call his mother while driving home from work, the voice command 121 received may be “call my mother.” The system 106 may separate the voice command 121 into two important keywords, i.e. “call” and “mother.” Additionally, to facilitate the extraction of keywords from associated voice commands 121, data tokenization 110 ranks keywords by frequency. A keyword used more often in voice commands 121 will be ranked higher than a keyword that is used less often during the data tokenization 110 process. Data tokenization 110 may further assist the marketing module 104 in categorizing the data it receives. A data categorization 111 step is discussed below which facilitates the generation of increasingly relevant and personalized incentive offers 105.

In an embodiment, after the voice command 121 data is tokenized 110, the system is configured to scan consumer data 122 to create relevant categories, referred to herein as the data categorization 111 step. The categories generated by data categorization 111 may give insight into consumer surroundings and provide the system 106 with relevant information that may be used to further tailor incentive offers 105. Data categorization 111 creates categories from consumer data 122 to define consumer context 123. For example, the incoming consumer data 122 may contain data pertaining to the physical location of the consumer 101. These unique data points assist in forming consumer context 123 and provide insight into the consumer's 101 current surroundings. Furthermore, individual categories' data points may be scaled up to add value to each category. For example, within a “location” category, the system 106 may add parameters, like the consumer's 101 city, state and zip code to location data that could be the GPS coordinates (latitude and longitude) from consumer data 122. These additional attributes may enhance the accuracy of the marketing module 104 by matching with retail offers that are applicable to the zip code that can be determined from consumer 101 location. By creating such precise categories through data categorization 111, consumers 101 may be matched with available retail offers 124 based on their closest matching postal code. Thus, the broader perspective provided by data categorization 111 may further assist the marketing module 104 to formulate relevant and targeted incentive offers 105 based on consumer data 122.

In an embodiment, voice command 121 and consumer data 122 may refer to a consumer's 101 habits, preferences and surroundings. For instance, a consumer 101 may inquire about current local weather conditions. The system 106 may use the data categorization step 111 to identify “weather” as a unique keyword and assign it to a “climate” category. Additionally, using the data compiled in the “climate” category, the marketing module 104 may be configured to consider the average temperature in the consumer's 101 location. Based on its analysis of data pertaining to average temperature readings, the tarketing module 104 may assess, for example, whether a consumer's 101 window glass is laminated. If the system's 106 analysis shows that the consumer's 101 window glass is not laminated, the marketing module 104 may assist in creating an incentive offer 105 for the purchase of window laminates. Hence, data categorization 111 may assist the marketing module 104 in analyzing which incentive offer(s) 105 will be of interest to a consumer 101.

After the dataset is tokenized 110 and categorized 111, it may be enriched with additional and relevant categories or attributes based on consumer data 122 as shared by voice assistant 102, herein referred to as the data enrichment 112 step. In data enrichment 112, tokenized and categorized data may be supplemented with additional information. For instance, a timestamp parameter may be manipulated to exhibit generic metrics like morning/afternoon/evening and the temperature parameter may be configured from specific temperatures to provide a more general low/average/high range. The additional information provided in the data enrichment step 112 may pertain to the consumer 101 being analyzed by the system 105 utilizing consumer data 122 shared by voice assistant 102, and may assist the marketing module 104 in delivering a more targeted and personalized incentive offer 105. For instance, during data enrichment 112, information about the specific preferences of consumer 101 and/or details about the consumer's 101 surrounding environment may be added to the dataset based on consumer data 122. This specific information may assist the marketing module 104 in gaining further details about the consumer's 101 surrounding environment, including but not limited to, the city, state and zip code of the consumer 101.

For example, in one embodiment, a consumer 101 commands the voice assistant 102 to call his mother. The consumer's mother fails to answer the call and the call is aborted. The voice assistant 102 shares the voice command 121 and consumer data 122 with the VAI 103. The system 106 may then use data enrichment 112 to add additional data such as upcoming holidays to the voice command 121 and consumer data 122. For example, if it is holiday season, the marketing module 104 may consider the most popular holiday in the consumer's location to enrich the data and tailor an incentive offer 105. If the consumer is calling his mother in America, data enrichment 112 may inform the system that it is Christmas time; while if the consumer is calling his mother in Israel, data enrichment 112 may inform the marketing module 104 that it is Hanukkah season. After the system enriches the data 112, the marketing module 104 may offer the consumer 101 an incentive offer 105 comprising a gift code, which may be purchased by the consumer 101 and delivered to the consumer's mother via the FM 107. This example shows how data enrichment 112 helps the system 106 generate on-target and personally tailored incentive offers 105.

Once data is tokenized 110, categorized 111, enriched 112 and processed by the marketing module 104, the updated consumer context 123 may be stored in the data warehouse 109. The data warehouse 109 is the system's 106 memory bank—data may be stored in the data warehouse 109 and remain accessible by the system 106 for future use. Data in the data warehouse 109 may be processed by the marketing module 104 as illustrated in FIG. 4. The memory of the data warehouse 109 may be any type of memory, including but not limited to random access memory (RAM), known to those skilled in the art.

FIG. 4 illustrates an embodiment of the marketing module 104. In the system 106, modules may comprise either: 1) software modules including, but not limited to, code embodied software modules on a non-transitory machine-readable medium; and/or 2) hardware-implemented modules. The marketing module 104 is a component capable of processing a particular set of algorithms. The set of algorithms may include, but is not limited to, at least one machine learning algorithm used to determine a consumer's 101 consumer context 123 and preferences. The algorithms may use K-means clustering to determine consumer context 123 and preferences, in order to make at least one targeted and personalized incentive offer 105. In an embodiment, the consumer context 123 may refer to relevant categories identified by a consumer's 101 current environment and preferences. These categories may be determined by performing K-means clustering on voice command 121 and consumer data 122 as shared by a voice assistant 102. A cluster may be created by identifying unique data attributes from consumer data 122. There may be at least one cluster that can be identified in the consumer data 122. For example, voice command 121 may indicate consumer 101's favorite radio station while consumer data 122 may indicate additional details about that radio station such as the music genre of that radio station and the current geographical location of consumer 101. Each of these attributes from consumer data 122 may be identified as a unique cluster. In this instance, “music genre” and “location” are two identified clusters. Therefore, every identified cluster may exhibit a unique trait about a consumer's 101 current profile and preferences. Every cluster which is identified by marketing module 104 may drive a unique strategy to create a personalized incentive offer 105.

In an embodiment, once the voice command 121 is tokenized 110 and each keyword has been assigned a frequency, the keywords are assigned to a best matched category as predicted by K-means clustering. In this case, K-means clustering may scan through at least the consumer data 122 and/or voice command 121 for a frequently occuiling word, e.g., a keyword. For example, K-means clustering obtains the keyword “pop music” and looks for groups of data associated with “music genre.” The algorithm may be configured to refine each cluster until no further refinements are possible. Furthermore, every improvement cycle may assign the keyword to a different cluster such as “radio channel.” Consequently, each cluster may contain refined keywords and exhibit unique traits. These keywords and traits may aid the system in tailoring incentive offers 105. For example, the K-means clustering algorithm of the marketing module 104 may analyze consumer context 123 and from its analysis may identify that consumer 101 consistently plays pop music radio channel every morning based on the voice command 121 as shared by the voice assistant 102. This analysis may then be used to help create an incentive offer 105 for an upcoming pop music concert in the locality as determined by consumer data 122 as shared by the voice assistant 102.

FIG. 4 also illustrates that the data warehouse 109 may be configured to store data associated with at least one consumer 101 in a database management system. This data may convey information including, but not limited to, voice command 121 and consumer data 122 which is received from the voice assistant 102 or consumer text 123 after it is determined by marketing module 104. The marketing module 104 may be configured to access the data in the data warehouse 109 via the methods available with a database management system.

In an embodiment, the marketing module 104 may generate at least one incentive offer 105 by matching the consumer context 123 with available ROs 124. ROs 124 are offers from retailers who have elected to service a consumer 101 who wishes to utilize at least one voice assistant 102. These ROs 124 are stored in a database management system. The matching process performed by the marketing module 104 may involve a cross reference table to sort and match the data. For instance, the consumer context 123 may indicate to the marketing module 104 that the consumer 101 is trying to call his mother and that the consumer 101 cannot reach his mother. The consumer context 123 also may indicate that it is holiday season. Consequently, the marketing module 104 may query all available RO's 124 to see if there is an incentive offer 105 for a popular gift for women, such as perfume or flowers.

In another embodiment, a consumer 101 may inquire about nearby restaurants from the consumer's 101 voice assistant 102. The consumer's voice command 121 may then be transmitted to the voice assistant 102. Based on the consumer's 101 identified food preferences and habits, the marketing module 104 may query all available RO's 124 to see if there is any matching gift code for nearby restaurants. This can be further extended to determine if the consumer is a vegetarian and prefers to eat at vegetarian restaurants. If so, the incentive offer 105 can be tailored to meet these specific preferences of the particular consumer 101. Once a consumer 101 accepts the incentive offer 105, the response is received by VAI 103 and forwarded to FM 107. FM 107 is then responsible to ensure delivery of the incentive offer 105 using consumer's preferred delivery method.

Additionally, the embodiment shown in FIG. 4 may include a data analytics 112 step. The data analytics 112 step may be carried out by an external data analyst or may be performed internally, depending on the desired system configuration. For example, in data analytics 112, a data analyst may examine data taken from the data warehouse 109 or assess the performance of the marketing module's 104 machine learning algorithms. Furthermore, the data analyst may help identify inefficiencies and ascertain ways to improve the marketing module's 104 machine learning algorithms.

While the best mode for carrying out the prefened embodiment of the invention has been illustrated and described in detail, those skilled in the art to which the invention pertains recognize that various alternative designs and embodiments other than those claimed below may fall within the scope and spirit of the disclosed invention.

1. A computerized system for marketing incentive offers via voice assistants, comprising:
an electronic voice assistant enabled to receive and transmit at least one voice command to a voice assistant interface;
said voice assistant interface tokenizing said voice command to identify unique and distinguished terms or keywords;
said voice assistant interface configured to forward said voice command and said tokens to a marketing module;
said marketing module categorizing said tokens using parameters formulated by customer data;
said marketing module enriching said tokens using parameters unique to a particular user of said voice assistant;
said marketing module formulating an incentive offer based at least in part on cross-referencing at least one retail offer with said tokens, said voice commands or said customer data; and
transmitting said incentive offer to the user of said voice assistant.

2. The system recited in claim 1, wherein:
said incentive offer is transmitted via said voice assistant.

3. The system recited in claim 1, wherein:
said marketing module identifies the consumer context unique to a particular user of said voice assistant; and
said marketing module fomiulates an incentive offer based at least in part on cross-referencing at least one retail offer with said consumer context.

4. The system recited in claim 1, wherein:
said voice assistant enabled to receive and transmit said customer data to said voice assistant interface; and
said voice assistant interface configured to forward said customer data to said marketing module.

5. The system recited in claim 1, wherein:
said system comprises a data warehouse;
said data warehouse comprises memory configured to store at least said tokens, said voice commands or said customer data; and
said stored tokens, said stored voice commands or said stored customer data is executable by said marketing module to perform at least cross-referencing said stored tokens, said stored voice commands or said stored customer data with at least one retail offer.

6. The system recited in claim 5, wherein:
said data warehouse stores additional data attributes based on each category of said consumer data.

7. The system recited in claim 5, wherein:
said customer data is stored in said data warehouse; and
said data warehouse is configured to forward said customer data to said marketing module.

8. The system recited in claim 5, wherein:
said system comprises a data analytics step wherein at least one data analyst performs one or more tasks, including examining data stored in said data warehouse or assessing the performance of at least one algorithm utilized or created by said marketing module.

9. The system recited in claim 1, wherein:
said voice assistant is configured to receive the user's acceptance or rejection of said incentive offer; and
said voice assistant is configured to transmit said acceptance or rejection to said voice assistant interface.

10. The system recited in claim 1, wherein:
said system comprises a fulfillment module wherein at least one delivery option for said incentive offer is executed.

11. The system recited in claim 10, wherein:
said fulfillment module stores at least one delivery option previously selected or utilized by a particular user of said voice assistant.

12. The system recited in claim 1, wherein:
formulating said incentive offer includes considering at least one of a voice assistant user's preferences or profile.

13. The system recited in claim 1, wherein:
formulating said incentive offer includes considering a voice assistant user's previous acceptance or rejection of incentive offers.

14. A method for marketing incentive offers via computerized voice assistants, comprising the steps of:
obtaining customer data and at least one voice command associated with a user of an electronic voice assistant:
obtaining at least one retail offer from one or more retailers;
determining preferences and profiles of said voice assistant user based at least in part on said customer data and said voice command;
matching at least one said retail offer with at least one of said preferences or said profiles of said voice assistant use; and
providing one or more incentive offers to said voice assistant user, said one or more incentive offers comprising information about said retail offer associated with at least one of said preferences or said profiles of said voice assistant user.

15. The method as recited in claim 14, wherein:
said one or more incentive offers being tailored to at least one particular voice assistant user such that at least one user associated with said voice assistant receives said incentive offers.

16. The method as recited in claim 14, wherein:
said incentive offers are further based on data regarding said voice assistant user's acceptance or rejection of past incentive offers.

17. The method as recited in claim 14, wherein:
said incentive offers are further based on the consumer context unique to a said voice assistant user.

18. One or more computer-readable media having computer executable instructions that, when executed by one or more processors, cause the one or more processors to perform operations comprising:
obtaining customer data and at least one voice command associated with a user of an electronic voice assistant;
obtaining at least one retail offer from one or more retailers;
determining preferences and profiles of said voice assistant user based at least in part on said customer data and said voice command data;
matching at least one said retail offer with at least one of said preferences or said profiles of said voice assistant user; and
providing one or more incentive offers to said voice assistant user, said one or more incentive offers comprising information about said retail offer associated with at least one of said preferences or said profiles of said voice assistant user.

19. The one or more computer-readable media as recited in claim 18, wherein:
said one or more incentive offers are tailored to at least one particular voice assistant user such that at least one user associated with said voice assistant receives said incentive offers.

20. The one or more computer-readable media as recited in claim 18, wherein:
said incentive offers are further based on data regarding said voice assistant user's acceptance or rejection of past incentive offers.

21. The one or more computer-readable media as recited in claim 18, wherein:
said incentive offers are further based on the consumer context unique to a said voice assistant user.
